(19) United States
(12) Patent Application Publication
(10) Pub. No.: US 2008/0085947 A1
(43) Pub. Date: Apr. 10, 2008

(54) Radiation curable matrix composition

(76) Inventors: Jeanette L. Ward, West Chicago, IL (US); Edward J. Murphy, Arlington Heights, IL (US); Kelly A. Hawkinson, Aurara, IL (US); James J. Schouten, St. Charles, IL (US)

Correspondence Address: NIXON & VANDERHYE, PC, 901 NORTH GLEBE ROAD, 11TH FLOOR, ARLINGTON, VA, 22203, US

(21) Appl. No.: 11/544,677

(22) Filed: Oct. 10, 2006

(51) Int. Cl. C03C 25/10

(52) U.S. Cl. 522/42

(57) ABSTRACT

Radiation curable compositions suitable for use a optical fiber ribbon matrix materials are provided which have at least two non-silicone urethane(meth)acrylate oligomers, one or more multifunctional diluents and one or more photoinitiators, wherein each of the non-silicone urethane(meth)acrylate oligomers has a number average molecular weight of about 200 or more, but less than about 6000, and the polydispersity index (PDI) of the urethane(meth)acrylate oligomers is from 2:1 to 30:1. The matrix material may be coated and cured on a plurality of optical fibers so as to form an optical fiber ribbon assembly.

### FIELD OF INVENTION

This invention relates to UV-curable liquid resin compositions useful as an optical fiber coating material, particularly, a matrix material.

### BACKGROUND OF THE INVENTION

Commonly, optical glass fibers are first individually coated with at least one ultra-violet light curable (hereinafter UV-curable) coating that adheres to the glass fiber, and thereafter color-coated with a UV-curable ink adhering to the coating. This ink layer serves as an identification of the individual glass fibers. A number of these individual color-coated optical glass fibers are bonded together in the ribbon assembly by use of a matrix material. Such optical glass fiber ribbon assemblies are widely used in telecommunications for the purpose of multi-channel signal transmission. The matrix material has the function of holding the individual optical glass fibers in alignment and protecting the same during handling and the installation environment. Often, the fibers are arranged in ribbon structures, having a generally flat, strand-like structure containing generally from about 4 to 24 fibers or more. Depending upon the application, a plurality of resulting ribbon assemblies can be combined into a cable which has from several up to about one thousand individually coated optical glass fibers. An example of a ribbon assembly is described in published European patent application No. 194891. An example of a plurality of ribbon assemblies combined together in a cable is disclosed in U.S. Pat. No. 4,906,067.

It is commonly required that, in use, branching optical fiber connections must be made at a location intermediate to the respective ends (or “termini”) of a given length of ribbon. Accessing the individual fibers in this manner is commonly referred to as “mid-span access” and presents special problems. Normal methods and tools for accessing the end or terminus of the ribbon assembly are generally not well adapted or are inoperable for providing mid-span access.

One known method for providing mid-span access is to contact the matrix material with a solvent, such as ethanol or isopropyl alcohol. Such a solvent must have the ability of swelling or softening the matrix material. At the same time, the solvent should be selected so as not to swell the coatings on the individual optical glass fibers. The swelling of the matrix material weakens that matrix material so that it can then be mechanically removed by mild scrubbing or similar mechanical means to remove the matrix material and thereby provide access to the individual, but still coated and color-identifiable, optical glass fibers. The matrix resin material and the solvent should be chosen together in order to be useful for this type of solvent stripping method.

It is also commonly required that, in use, separate lengths of ribbon assemblies must be connected together at their ends (hereinafter “end-access”). Typically, this is achieved by fusion of respective ends of the fibers. For this purpose, it is important to secure a connection with minimum signal loss or attenuation.

A known method for achieving end-access of the optical glass fibers at a terminus of the ribbon assembly is to use a heat stripping method. A heat stripping method typically utilizes a heat stripping tool. Such a tool consists of two plates provided with heating means. An end section of the ribbon assembly is pinched between the two heated plates and the heat of the tool softens the matrix material and softens the coatings on the individual optical glass fiber. The heat-softened matrix material and the heat-softened coatings present on the individual optical glass fibers can then be removed to provide bare optical glass fiber ends, at which the connections can be made. A knife cut is often used to initiate a break in the matrix material. Typically, only a ¼ to ½ inch section of the matrix material and coatings on the optical glass fibers need be removed so that identification of the bare individual optical glass fibers can be made by tracing back along the bare optical fiber until the colored coating is seen.

There is a need for matrix compositions which, when used in a fiber assembly, possess the combination of functional properties so as to permit both easy and effective mid-span access of the optical glass fibers using a solvent stripping method, and also easy and effective end-access of the optical glass fibers using a heat stripping method. There is also a need for matrix compositions containing oligomers having good compatibility with other ingredients, and the composition, when stored, having reliable batch-to-batch consistency. Furthermore, matrix compositions that provide adequate cure speed are desired.

### SUMMARY OF THE INVENTION

One aspect of the invention is in a radiation curable composition comprising:
a) At least two urethane(meth)acrylate oligomers;
b) One or more multifunctional diluents;
c) One or more photoinitiators;
   wherein:
i) the urethane(meth)acrylate oligomers are non-silicone oligomers;
ii) each of said urethane(meth)acrylate oligomers has a number average molecular weight of about 200 or more, but less than about 6000; and
iii) the polydispersity index of said urethane(meth)acrylate oligomers is from about 2:1 to about 30:1.

Another aspect of the invention is in a radiation curable composition comprising:
a) from about 40 wt % to about 90 wt %, relative to the total weight of the composition, of at least two urethane(meth)acrylate oligomers;
b) from about 1 wt % to about 30 wt %, relative to the total weight of the composition, of one or more multifunctional diluents;
c) about 10 wt % to about 35 wt %, relative to the total weight of the composition, of one or more monofunctional diluents;
d) from about 0.5 wt % to about 8 wt %, relative to the total weight of the composition, of one or more photoinitiators;
e) from about 0.1 wt % to about 3 wt %, relative to the total weight of the composition, of one or more antioxidants;
f) from about 0.1 wt % to about 3 wt %, relative to the total weight of the composition, of one or more silicone additives, wherein
i) the urethane(meth)acrylate oligomers are non-silicone oligomers;
ii) each of said urethane(meth)acrylate oligomers has a number average molecular weight of about 200 or more, but less than about 6000; and
iii) the polydispersity index (PDI) of said urethane(meth)acrylate oligomers is from about 2:1 to about 30:1.

Yet another aspect of the invention is in an optical fiber ribbon assembly comprising:
(a) a plurality of coated optical glass fibers; and
(b) a matrix material binding together said plurality of coated optical glass fibers, said matrix material having the composition comprising:
   1) At least two urethane(meth)acrylate oligomers;
   2) One or more multifunctional diluents;
   3) One or more photoinitiators;
      wherein:
   i) the urethane(meth)acrylate oligomers are non-silicone oligomers;
   ii) each of said urethane(meth)acrylate oligomers has a number average molecular weight of about 200 or more, but less than about 6000; and
   iii) the polydispersity index of said urethane(meth)acrylate oligomers is from about 2:1 to about 30:1.

Another aspect of the invention is in a method of making an optical fiber assembly ribbon comprising:

Coating on a plurality of coated optical glass fibers a matrix material which binds the plurality of coated optical fibers together, wherein the matrix material has a composition comprising:
1) At least two urethane(meth)acrylate oligomers;
2) One or more multifunctional diluents;
3) One or more photoinitiators;
   and wherein:
   i) the urethane(meth)acrylate oligomers are non-silicone oligomers;
   ii) each of said urethane(meth)acrylate oligomers has a number average molecular weight of about 200 or more, but less than about 6000; and
   iii) the polydispersity index of said urethane(meth)acryalte oligomers is from about 2:1 to about 30:1.

A further aspect of this invention is in a method of making an optical fiber assembly ribbon comprising:
(A) applying on a plurality of coated optical glass fibers a matrix coating of a radiation-curable matrix material having a composition comprising:
   1) At least two urethane(meth)acrylate oligomers;
   2) One or more multifunctional diluents;
   3) One or more photoinitiators;
      wherein:
   i) the urethane(meth)acrylate oligomers are non-silicone oligomers;
   ii) each of the urethane(meth)acrylate oligomers has a number average molecular weight of about 200 or more, but less than about 6000; and
   iii) the polydispersity index of the urethane(meth)acrylate oligomers is from about 2:1 to about 30:1, and thereafter
(B) exposing the matrix coating applied according to step (A) to radiation sufficient to cure the matrix material and bind the plurality of optical fibers together.

### DETAILED DESCRIPTION OF PREFERRED EMBODIMENTS

As used in this specification and the appended claims, the following terms have the indicated meanings:

“Non-silicone” urethane(meth)acrylate oligomer refers to the urethane(meth)acrylate oligomer containing no silicone moiety in its structure.

“Polydispersity index” (PDI) of a group of urethane(meth)acrylate oligomers refers to the ratio of the number-average molecular weight of the urethane(meth)acrylate oligomer having the highest number average molecular weight to the number-average molecular weight of the urethane(meth)acrylate oligomer having the lowest number average molecular weight. In case all the urethane(meth)acrylate oligomers in the composition have same number-average molecular weight, the polydispersity index of these oligomers is 1:1.

When only a single urethane(meth)acrylate oligomer is used in a composition, the polydispersity index is 1:1.

The term “(meth)acrylate” means either methacrylate or acrylate or it means methacrylate and acrylate.

“Room temperature” refers to a temperature of 23±3° C.

“E′₁₀₀−E′₁₀₀₀” refers to the difference between the temperature at the DMA-derived elastic modulus E′₁₀₀ and the temperature at the DMA-derived elastic modulus E′₁₀₀₀.

“DMA-derived elastic modulus E′₁₀₀” refers to the modulus of 100 MPa on the DMA (Dynamic Mechanical Analysis) graph.

“DMA-derived elastic modulus E′₁₀₀₀” refers to the modulus of 1000 MPa on the DMA (Dynamic Mechanical Analysis) graph.

“Tg” refers to the glass transition temperature.

One embodiment of the invention is in a radiation curable composition comprising:
a) At least two urethane(meth)acrylate oligomers;
b) One or more multifunctional diluents;
c) One or more photoinitiators;
   wherein:
i) the urethane(meth)acrylate oligomers are non-silicone oligomers;
ii) each of the urethane(meth)acrylate oligomers has a number average molecular weight of about 200 or more, but less than about 6000; and
iii) the polydispersity index of the urethane(meth)acrylate oligomers is from about 2:1 to about 30:1.

At least two urethane(meth)acrylate oligomers, for example, three or more, or four or more urethane(meth)acrylate oligomers, are used in the compositions of the present invention. Suitable urethane(meth)acrylate oligomers of the present invention are produced by either:

1) reacting a polyol, a polyisocyanate, and a hydroxyl group-containing (meth)acrylate; or by

2) reacting a polyisocyanate and a hydroxyl group-containing (meth)acrylate.

In case 1), the urethane(meth)acrylate oligomer is produced by reacting isocyanate groups of the polyisocyanate with a hydroxyl group of the polyol and a hydroxyl group of the hydroxyl group-containing (meth)acrylate.

This reaction is carried out by either:

1) reacting the polyol, polyisocyanate, and hydroxyl group-containing (meth)acrylate all together; or by

2) reacting the polyol and the polyisocyanate, and reacting the resulting product with the hydroxyl group-containing (meth)acrylate; or by

3) reacting the polyisocyanate and the hydroxyl group-containing (meth)acrylate, and reacting the resulting product with the polyol; or by

4) reacting the polyisocyanate and the hydroxyl group-containing (meth)acrylate, reacting the resulting product with the polyol, and further reacting the resulting product with the hydroxyl group-containing (meth)acrylate.

There are no specific limitations to the manner of polymerization of the structural units of the polyol, which may be any of random polymerization, block polymerization, and graft polymerization.

Suitable polyol backbones of the urethane(meth)acrylate oligomer include polyether polyol, polyester polyol, polycarbonate polyol, polycaprolactone polyol or copolymers thereof. Preferred polyol backbones are selected from the group comprising polyether polyol, polyester polyol, polycarbonate polyol. The backbone can comprise one or more oligomeric blocks, for example, di-block, tri-block, tetra-block.

Suitable polyether polyol backbones include polyethylene glycol, polypropylene glycol, polytetramethylene glycol, polyhexamethylene glycol, polyheptamethylene glycol, polydecamethylene glycol, aliphatic polyether polyol obtained by ring-opening copolymerization of two or more ion-polymerizable cyclic compounds. Examples of the ion-polymerizable cyclic compound include cyclic ethers such as ethylene oxide, propylene oxide, butene-1-oxide, isobutene oxide, 3,3-bischloromethyloxetane, tetrahydrofuran, 2-methyltetrahydrofuran, 3-methyltetrahydrofuran, dioxane, trioxane, tetraoxane, cyclohexene oxide, styrene oxide, glycidyl methacrylate, allyl glycidyl ether, allyl glycidyl carbonate, butadiene monoxide, vinyloxetane, vinyltetrahydrofuran, vinylcyclohexene oxide, phenyl glycidyl ether, butyl glycidyl ether.

Examples of specific combinations of the ion-polymerizable cyclic compounds include tetrahydrofuran and propylene oxide, tetrahydrofuran and 2-methyltetrahydrofuran, tetrahydrofuran and 3-methyltetrahydrofuran, tetrahydrofuran and ethylene oxide, propylene oxide and ethylene oxide, butene-1-oxide and ethylene oxide, a ternary copolymer of tetrahydrofuran, butene-1-oxide, and ethylene oxide. The ring-opening copolymer of the ion-polymerizable cyclic compounds may be a random copolymer or a block copolymer.

Further examples of the polyether polyol include cyclic polyether polyols such as alkylene oxide addition polyol of bisphenol A, alkylene oxide addition polyol of bisphenol F, hydrogenated bisphenol A, hydrogenated bisphenol F, alkylene oxide addition polyol of hydrogenated bisphenol A, alkylene oxide addition polyol of hydrogenated bisphenol F, 1,4-cyclohexane polyol and alkylene oxide addition polyol thereof, tricyclodecane polyol, tricyclodecanedimethanol. These polyols are commercially available as Uniol DA400, DA700, DA1000, DB400 (manufactured by Nippon Oil and Fats Co., Ltd. (www.nof.co.jp/english)), tricyclodecanedimethanol (manufactured by Mitsubishi Chemical Corp. (www.m-kagaku.co.jp)).

The polyether polyol backbone may comprise more than one oligomeric polyether blocks.

Suitable polyester polyols may be obtained by reacting a dihydric alcohol and a dibasic acid. Suitable dihydric alcohols include ethylene glycol, polyethylene glycol, propylene glycol, polypropylene glycol, tetramethylene glycol, polytetramethylene glycol, 1,6-hexane polyol, neopentyl glycol, 1,4-cyclohexanedimethanol, 3-methyl-1,5-pentane polyol, 1,9-nonane polyol, 2-methyl-1,8-octane polyol. Suitable dibasic acids include phthalic acid, isophthalic acid, terephthalic acid, maleic acid, fumaric acid, adipic acid, and sebacic acid. These polyester polyols are commercially available as Kurapol P-2010, PMIPA, PKA-A, PKA-A2, PNA-2000 (manufactured by Kuraray Co., Ltd. (www.kuraray.co.jp/en/)).

Examples of the polycarbonate polyol include polycarbonate of polytetrahydrofuran, polycarbonate of 1,6-hexane polyol. These polycarbonate polyols are commercially available as DN-980, DN-981, DN-982, DN-983 (manufactured by Nippon Polyurethane Industry Co., Ltd. (www.npu.com.cn/english)), PC-8000 (manufactured by PPG (www.ppg.com)), PC-THF-CD (manufactured by BASF (www.corporate.basf.com/en)).

Polyols other than those mentioned above may also be used. These polyols include hydroxy-terminated polybutadiene, hydroxy-terminated hydrogenated polybutadiene and the like.

Among the above-mentioned polyols, the polyether polyol, particularly the aliphatic polyether polyols, are preferable. Specifically, polypropylene glycol, copolymer of butene-1-oxide and ethylene oxide are preferable. These polyols are commercially available as PPG400, PPG425, PPG1000, PPG2000, PPG3000, Excenol 720, 1020, 2020 (manufactured by Asahi Glass Urethane Co., Ltd. (www.agc.co.jp/english)). The copolymer diol of butene-1-oxide and ethylene oxide is commercially available as EO/BO500, EO/BO1000, EO/BO2000, EO/BO3000, EO/BO4000 (manufactured by Daiichi Kogyo Seiyaku Co., Ltd.(www.dks-web.co.jp)).

Polyisocyanates suitable for use in making the compositions of the invention include diisocyanates such as 2,4-tolylene diisocyanate, 2,6-tolylene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, 1,6-hexane diisocyanate, isophorone diisocyanate, methylenebis(4-cyclohexyl isocyanate), 2,2,4-trimethylhexamethylene diisocyanate, bis(2-isocyanate ethyl)fumarate, 6-isopropyl-1,3-phenyl diisocyanate, 4-diphenylpropane diisocyanate. These polyisocyanates may be used either individually or in combination of two or more.

Suitable hydroxyl group-containing (meth)acrylates include 2-hydroxyethyl(meth)acrylate, 2-hydroxypropyl(meth)acrylate, 2-hydroxybutyl(meth)acrylate, 2-hydroxy-3-phenyloxypropyl(meth)acrylate, 1,4-butane polyol mono(meth)acrylate, 2-hydroxyalkyl(meth)acryloyl phosphate, 4-hydroxycyclohexyl(meth)acrylate, 1,6-hexanepolyol mono(meth)acrylate, neopentyl glycol mono(meth)acrylate, trimethylolpropane di(meth)acrylate, trimethylolethane di(meth)acrylate, pentaerythritol tri(meth)acrylate, dipentaerythritol penta(meth)acrylate.

Another example of hydroxyl group-containing (meth)acrylate is a compound obtained by the addition reaction of (meth)acrylic acid and a glycidyl group-containing compound, such as alkyl glycidyl ether, allyl glycidyl ether, or glycidyl(meth)acrylate.

Of these hydroxyl group-containing (meth)acrylates, 2-hydroxyethyl (meth)acrylate and 2-hydroxypropyl (meth)acrylate are preferred.

These hydroxyl group-containing (meth)acrylate compounds may be used either individually or in combination of two or more.

For urethane(meth)acrylate oligomers prepared by reacting a polyol, a polyisocyanate, and a hydroxyl group-containing (meth)acrylate, the polyol, polyisocyanate, and hydroxyl group-containing (meth)acrylate are preferably used so that the isocyanate group in the polyisocyanate and the hydroxyl group in the hydroxyl group-containing (meth)acrylate are respectively about 1.1 to about 3 equivalents and about 0.2 to about 1.5 equivalents for one equivalent of the hydroxyl group in the polyol.

In the reaction of these compounds, it is preferable to use a urethanization catalyst, such as copper naphthenate, cobalt naphthenate, zinc naphthenate, dibutyltin dilaurate, triethylamine, 1,4-diazabicyclo[2.2.2]octane, or 2,6,7-trimethyl-1,4-diazabicyclo[2.2.2]octane, in an amount of 0.01 wt % to 1 wt %, relative to the total weight of the reactants. The reaction temperature is usually about 10° C. to about 90° C., and preferably about 30° C. to about 80° C.

When the urethane(meth)acrylate oligomer is produced by reacting a polyisocyanate and the hydroxyl group-containing (meth)acrylates, each isocyanate group will react with a hydroxyl group of the hydroxyl group-containing (meth)acrylate.

Suitable polyisocyanates and hydroxyl group-containing (meth)acrylates may be any one or more of those described previously.

One example of this group of urethane(meth)acrylate oligomers is the oligomer H-T-H, wherein H represents 2-hydroxy ethyl acrylate and T represents toluene diisocyanate.

The hydroxyl groups that react with the polyisocyanate can belong to identical hydroxyl group-containing (meth)acrylates or different hydroxyl group-containing (meth)acrylates.

The above-mentioned two types of urethane(meth)acrylate oligomers can be used together to form the compositions of the present invention.

The urethane(meth)acrylate oligomers used in the present invention are non-silicone oligomers.

In one embodiment, each of the urethane(meth)acrylate oligomers in the present invention has a number average molecular weight of about 200 or more, but less than about 6000. In another embodiment, each of the urethane(meth)acrylate oligomers in the present invention has a number average molecular weight of about 300 or more, but less than about 5500. In a further embodiment, each of the urethane(meth)acrylate oligomers in the present invention has a number average molecular weight of about 1000 to about 5000.

The polydispersity index of the urethane(meth)acrylate oligomers of the present invention is from about 2:1 to about 30:1. In another embodiment, the polydispersity index of the urethane(meth)acrylate oligomers is from about 2.5:1 to about 20:1. In a further embodiment, the polydispersity index of the urethane(meth)acrylate oligomers is from about 3:1 to about 15:1.

In one embodiment, the total weight percentage (wt %) of all the urethane(meth)acrylate oligomers in the present invention is from about 40 wt % to about 90 wt %, relative to the total weight of the composition; In another embodiment, the total wt % of all the urethane(meth)acrylate oligomers in the present invention is from about 50 wt % to about 80 wt %, relative to the total weight of the composition.

One or more multifunctional diluents are used in the radiation curable composition of the present invention.

Suitable multifunctional diluents are selected from the group comprising trimethylolpropane tri(meth)acrylate, pentaerythritol(meth)acrylate, ethylene glycol di(meth)acrylate, tetraethylene glycol di(meth)acrylate, polyethylene glycol di(meth)acrylate, 1,4-butanediol di(meth)acrylate, 1,6-hexanediol di(meth)acrylate, neopentyl glycol di(meth)acrylate, polybutanediol di(meth)acrylate, tripropyleneglycol di(meth)acrylate, glycerol tri(meth)acrylate, phosphoric acid mono- and di(meth)acrylates, C7-C20 alkyl di(meth)acrylates, trimethylolpropanetrioxyethyl(meth)acrylate, tris(2-hydroxyethyl)isocyanurate tri(meth)acrylate, tris(2-hydroxyethyl)isocyanurate di(meth)acrylate, pentaerythritol tri(meth)acrylate, pentaerythritol tetra(meth)acrylate, dipentaerythritol monohydroxy pentacrylate, dipentaerythritol hexacrylate, tricyclodecane diyl dimethyl di(meth)acrylate and alkoxylated versions (preferably ethoxylated and/or propoxylated) of any of the preceding monomers, and also di(meth)acrylate of a diol which is an ethylene oxide or propylene oxide adduct to bisphenol A, di(meth)acrylate of a diol which is an ethylene oxide or propylene oxide adduct to hydrogenated bisphenol A, epoxy (meth)acrylate which is a (meth)acrylate adduct to bisphenol A of diglycidyl ether, diacrylate of polyoxyalkylated bisphenol A, and triethylene glycol divinyl ether.

One or more monofunctional diluents may be used in combination with one or more multifunctional diluents in the composition of the present invention. The monofunctional diluent can contain acrylate group (acrylate diluent) or non-acrylate group (non-acrylate diluent). Suitable monofunctional diluents are selected from the group comprising N-vinyl pyrrolidone, N-vinyl caprolactam, vinyl imidazole, vinyl pyridine; isobornyl(meth)acrylate, bornyl(meth)acrylate, tricyclodecanyl(meth)acrylate, dicyclopentanyl(meth)acrylate, dicyclopentenyl(meth)acrylate, cyclohexyl(meth)acrylate, benzyl(meth)acrylate, 4-butylcyclohexyl(meth)acrylate, acryloyl morpholine, (meth)acrylic acid, 2-hydroxyethyl(meth)acrylate, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl(meth)acrylate, pentyl(meth)acrylate, caprolactone acrylate, isoamyl(meth)acrylate, hexyl(meth)acrylate, heptyl(meth)acrylate, octyl(meth)acrylate, isooctyl(meth)acrylate, 2-ethylhexyl(meth)acrylate, nonyl(meth)acrylate, decyl(meth)acrylate, isodecyl(meth)acrylate, tridecyl(meth)acrylate, undecyl(meth)acrylate, lauryl(meth)acrylate, stearyl(meth)acrylate, isostearyl(meth)acrylate, tetrahydrofurfuryl(meth)acrylate, butoxyethyl(meth)acrylate, ethoxydiethylene glycol(meth)acrylate, benzyl(meth)acrylate, phenoxyethyl(meth)acrylate, polyethylene glycol mono(meth)acrylate, polypropylene glycol mono(meth)acrylate, methoxyethylene glycol(meth)acrylate, ethoxyethyl(meth)acrylate, methoxypolyethylene glycol(meth)acrylate, methoxypolypropylene glycol(meth)acrylate, diacetone(meth)acrylamide, beta-carboxyethyl(meth)acrylate, phthalic acid(meth)acrylate, isobutoxymethyl(meth)acrylamide, N,N-dimethyl(meth)acrylamide, t-octyl(meth)acrylamide, dimethylaminoethyl(meth)acrylate, diethylaminoethyl(meth)acrylate, butylcarbamylethyl(meth)acrylate, n-isopropyl(meth)acrylamide fluorinated(meth)acrylate, 7-amino-3,7-dimethyloctyl(meth)acrylate, N,N-diethyl(meth)acrylamide, N,N-dimethylaminopropyl(meth)acrylamide, hydroxybutyl vinyl ether, lauryl vinyl ether, cetyl vinyl ether, 2-ethylhexyl vinyl ether and alkoxylated aliphatic monofunctional monomers such as ethoxylated isodecyl(meth)acrylate, ethoxylated lauryl(meth)acrylate.

In one embodiment, the total wt % of the multifunctional diluents in the present invention is about 1 wt % to about 40 wt %, relative to the total weight of the radiation curable composition. In another embodiment, the total wt % of the multifunctional diluents in the present invention is about 1 wt % to about 30 wt %, relative to the total weight of the radiation curable composition.

When monofunctional diluents are also present, the total wt % of the monofunctional diluents is about 5 wt % to about 40 wt %, relative to the total weight of the radiation curable composition. In another embodiment, the wt % of the monofunctional diluents in the present invention is about 10 wt % to about 35 wt %, relative to the total weight of the radiation curable composition.

The radiation curable composition of the present invention can be cured by ultraviolet (UV) light or by electron beam (EB). It is preferred to cure using UV light.

One or more photoinitiators to initiate the polymerization reaction to cure the composition are used in the composition. Examples of suitable photoinitiators are 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl methyl ketal, 1-(4-isopropylphenyl)-2-hydroxy-2-methylpropan-1-one, 2-hydroxy-2-methyl-1-phenylpropan-1-one, thioxanethone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyl diphenylphosphine oxide, bis-(2,6-dimethoxybenzoyl)-2,4,4-trimethylpentylphosphine oxide. Commercially available photoinitiators include Irgacure 184, Irgacure 369, Irgacure 651, Irgacure 500, Irgacure 907, CGI 1750, CGI 1850, Darocure 1116, Darocure 1173 (manufactured by Ciba Specialty Chemicals Co. (www.cibasc.com)); Lucirin TPO (manufactured by BASF (www.corporate.basf.com/en)); Ubecryl P36 (manufactured by UCB (www.ucb-group.com)).

A photosensitizer may be used in combination with the photoinitiator. Suitable photosensitizers include triethylamine, diethylamine, N-methyldiethanoleamine, ethanolamine, 4-dimethylaminobenzoic acid, methyl 4-dimethylamninobenzoate, ethyl 4-dimethylaminobenzoate, isoamyl 4-dimethylaminobenzoate.

In one embodiment, the total wt % of the photoinitiators used in this invention is from about 0.1 wt % to about 10 wt %, relative to the total weight of the radiation curable composition. In another embodiment, the total wt % of the photoinitiators is from about 0.5 wt % to about 8 wt %, relative to the total weight of the radiation curable composition. In another embodiment, the total wt % of the photoinitiators is from about 1 wt % to about 6 wt %, relative to the total weight of the radiation curable composition.

In addition to the above-described compounds, various additives such as antioxidants, UV absorbers, photo-stabilizers, coating surface improvers, heat polymerization inhibitors, leveling agents, slip additives, releasing agents, surfactants, colorants, preservatives, plasticizers, lubricants, solvents, fillers, aging preventives, antiblocking agents and wettability improvers can be used in the liquid curable resin compositions of the present invention.

Commercially available antioxidants include Irganox 1010, Irganox 1035, Irganox 1076, Irganox 1222 (Ciba Geigy (www.ciba.com)), GA-80 (Sumitomo Chemical Industries Co., Ltd. (www.sumitomo-chem.co.jp/english/)). Commercially available UV absorbers include Tinuvin P, Tinuvin 327, Tinuvin 329 (Ciba Geigy (www.ciba.com)), Seesorb 102, Seesorb 103, Seesorb 704 (manufactured by Shipro Chemical Co. (www.shipro.co.jp)).

In one embodiment, the total wt % of antioxidants used in the present invention is from about 0.01 wt % to about 5 wt %, relative to the total weight of the radiation curable composition. In another embodiment, the total wt % of antioxidants is from about 0.1 wt % to about 3 wt %, relative to the total weight of the radiation curable composition.

Commercially available photo-stabilizers include Tinuvin 292, 144, 622LD (manufactured by Ciba Geigy (www.ciba.com)), Sanol LS770 (manufactured by Sankyo Chemical Co.( www.sankyo-chem-ind.co.jp)), and SUMISORB TM-061 (manufactured by Sumitomo Chemical Industries (www.sumitomo-chem.co.jp/english)).

In one embodiment, the total wt % of photo-stabilizers is from about 0.01 wt % to about 7 wt %, relative to the total weight of the radiation curable composition. In another embodiment, the total wt % of photo-stabilizers is from about 0.1 wt % to about 5 wt %, relative to the total weight of the radiation curable composition.

Silicone additives may be used as leveling agents, slip additives, releasing agents or surface improvers. Suitable silicone additives are selected from the group comprising dimethylsiloxane polyether and commercially available products such as DC-57, DC-190 (Dow Corning (www.dowcorning.com)), SH-28PA, SH-30PA, SH-190 (Toray-Dow Corning (www.dowcorning.com)), KF351, KF352, KF353 (Shin-Etsu Chemical Industries (www.shinetsu.co.jp/e)), and L-7002, L-7500, FK-024-90 (Nippon Unicar (www.unicar.jp)), Ebecryl 350 (UCB (www.ucb.com)), Tegorad 2200N (Tegotechnology (www.tegotechnology.com))

In one embodiment of the present invention, the total wt % of silicone additives is from about 0.05 wt % to about 5 wt %, relative to the total weight of the radiation curable composition. In another embodiment, the total wt % of silicone additives is from about 0.1 wt % to about 3 wt %, relative to the total weight of the radiation curable composition.

An amine compound can be added to the liquid curable resin composition of the present invention as an additive to prevent generation of hydrogen gas, which causes transmission loss in the optical fibers. Suitable amines include diallylamine, diisopropylamine, diethylamine, diethylhexylamine.

In one embodiment, the wt % of amine compound is from about 0.01 wt % to about 7.0 wt %, relative to the total weight of the radiation curable composition. In another embodiment, the wt % of amine compound is about 0.1 wt % to about 5 wt %, relative to the total weight of the radiation curable composition. In a further embodiment, the wt % of amine compound is from about 0.5% to about 4 wt %, relative to the total weight of the radiation curable composition.

The composition of the present invention is prepared by mixing the oligomers, diluents, photoinitiators and additives together and stirring the mixture at 50° C.-60° C. until the mixture becomes homogeneous.

Another embodiment of the invention is a radiation curable composition comprising:
a) from about 40 wt % to about 90 wt %, relative to the total weight of the composition, of at least two urethane(meth)acrylate oligomers;
b) from about 1 wt % to about 30 wt %, relative to the total weight of the composition, of one or more multifunctional diluents;
c) about 10 wt % to about 35 wt %, relative to the total weight of the composition, of one or more monofunctional diluents;
d) from about 0.5 wt % to about 8 wt %, relative to the total weight of the composition, of one or more photoinitiators;
e) from about 0.1 wt % to about 3 wt %, relative to the total weight of the composition, of one or more antioxidants;
f) from about 0.1 wt % to about 3 wt %, relative to the total weight of the composition, of one or more silicone additives, wherein
i) the urethane(meth)acrylate oligomers are non-silicone oligomers;
ii) each of said urethane(meth)acrylate oligomers has a number average molecular weight of about 200 or more, but less than about 6000; and
iii) the polydispersity index (PDI) of the urethane(meth)acrylate oligomers is from about 2:1 to about 30:1.

In another embodiment, the present invention includes a cured material which is the radiation-initiated reaction product of a curable resin composition.

Yet another embodiment of the present invention is an optical fiber ribbon assembly comprising:
(a) a plurality of coated optical glass fibers; and
(b) a matrix material binding together said plurality of coated optical glass fibers, said matrix material having the composition comprising:
   1) At least two urethane(meth)acrylate oligomers;
   2) One or more multifunctional diluents;
   3) One or more photoinitiators;
wherein:
   i) the urethane(meth)acrylate oligomers are non-silicone oligomers;
   ii) each of the urethane(meth)acrylate oligomers has a number average molecular weight of about 200 or more, but less than about 6000; and
   iii) the polydispersity index of the urethane(meth)acrylate oligomers is from about 2:1 to about 30:1.

According to yet another embodiment of the invention, a method is provided to make an optical fiber assembly ribbon comprising: Coating on a plurality of coated optical glass fibers a matrix material which binds the plurality of coated optical fibers together, wherein said matrix material has a composition comprising:
1) At least two urethane(meth)acrylate oligomers;
2) One or more multifunctional diluents;
3) One or more photoinitiators;
   wherein:
   i) the urethane(meth)acrylate oligomers are non-silicone oligomers;
   ii) each of the urethane(meth)acrylate oligomers has a number average molecular weight of about 200 or more, but less than about 6000; and
   iii) the polydispersity index of the urethane(meth)acrylate oligomers is from about 2:1 to about 30:1.

The individual elements of the embodiments of this invention described above are the same as those individual elements of the invention which have been previously described. As such, a description of such individual elements will not be repeated here.

The compositions of the present invention are typically cured using UV light generated by a fusion D-lamp in a nitrogen atmosphere at a cure dose of 1 J/cm². The typical sample coating thickness is about 75 μm.

In one embodiment, the compositions of the present invention, when cured, have a secant modulus of at least 100 MPa. In another embodiment, the coating compositions of the present invention, when cured, have a secant modulus of about 100 MPa to about 600 MPa. In a further embodiment, the coating compositions of the present invention, when cured, have a secant modulus of about 150 MPa to about 500 MPa.

The test method for secant modulus is described in the tensile strength, elongation and secant modulus test methods (TEM) presented in US publication 2006/0084716A1, page 9, paragraphs [0078]-[0088], which is herein incorporated in its entirety by reference.

The compositions of the present invention, when cured, preferably have an elongation at break of at least about 15%. In another embodiment, the composition, when cured, have an elongation at break of from about 15% to about 100%. In a further embodiment, the composition, when cured, have an elongation at break of from about 20% to about 80%.

The test method for elongation at break is described in the tensile strength, elongation and secant modulus test methods (TEM) presented in US publication 2006/0084716A1, page 9, paragraphs [0078]-[0088], which is herein incorporated in its entirety by reference.

The radiation curable compositions of the present invention preferably have a viscosity of from about 3000 mPa·s to about 8000 mPa·s at 25° C. In another embodiment, the viscosity of the radiation curable compositions is from about 4000 mPa·s to about 7000 mPa·s at 25° C.

The test method for determining viscosity of the curable compositions is described in US publication 2006/0084716A1, page 10, paragraphs [0093]-[0095], which is herein incorporated in its entirety by reference.

The compositions of the present invention, when cured, are preferably hydrolytically stable to such an extent that the coating maintains mechanical integrity when aged at 85° C. and 85% relative humidity for 2, 4, 8 and 12 weeks. Mechanical integrity means that the coating sample remains intact to such an extent that the coating sample can be measured in a Dynamic Mechanical Analysis (DMA) measurement as described in more detail in page 34. Preferably, the coating composition does not fall apart when a sample is prepared for the DMA measurement.

The test method for hydrolytic stability is described in US publication 2006/0084716A1, page 10, paragraphs [0092], which is herein incorporated in its entirety by reference.

The compositions of the present invention, when cured and aged for 2 weeks under 85° C. and 85% Relative Humidity, preferably exhibit a change in equilibrium modulus Eₒ of about 20% or less. In another embodiment, the change in equilibrium modulus Eₒ after aging for 2 weeks is about 10% or less. When cured and aged for 4 weeks under 85° C. and 85% Relative Humidity, the compositions of the invention preferably exhibit a change in equilibrium modulus of about 23% or less. In another embodiment, the change in equilibrium modulus Eₒ after aging for 4 weeks is about 21% or less. When cured and aged for 8 weeks under 85° C. and 85% Relative Humidity, the compositions of the invention preferably exhibit a change in equilibrium modulus of about 25% or less. In another embodiment, the change in equilibrium modulus Eₒ after aging for 8 weeks is about 23% or less. When cured and aged for 12 weeks under 85° C. and 85% Relative Humidity the compositions preferably exhibit a change in equilibrium modulus of about 28% or less. In another embodiment, the change in equilibrium modulus Eₒ after aging for 12 weeks is about 25% or less.

The matrix material compositions of the invention are composed such that when the coating compositions are cured, the matrix material possesses a swell index and a Tg that provides the combination of both mid—span access to the optical glass fibers using a solvent stripping method and end-access to the optical glass fibers using a heat stripping method.

The swell index of the cured matrix material can be determined by measuring the initial weight of the matrix material, immersing the matrix material in a solvent, and then measuring the weight of the matrix material after immersion. The swell index is the percent change in weight of the matrix material.

The swell index of the matrix material will depend on the particular solvent selected. Any solvent can be used which (1) causes the matrix material to swell, and (2) which does not unacceptably and deleteriously affect the coatings on the optical glass fibers. Based on the disclosure provided herein, one skilled in the art will easily be able to determine which solvents are suitable for swelling the matrix material. Examples of suitable solvents have been found to be ethanol and/or isopropyl alcohol. In the present invention, a mixture of ethanol/water is used as solvent for the swell index evaluation. Hereinafter, the phrase “swell index” will be understood as “ethanol swell index” to reflect the fact that ethanol is the solvent. The test method for determining the “ethanol swell index” is described in greater detail below.

It is desirable that the matrix material swells in the solvent up to 20 minutes, or up to 40 minutes, depending on the test or user requirement. Preferably, the cured matrix material is immersed in the solvent at room temperature. However, if desired, the solvent can be heated to increase the speed of the swelling of the matrix material. The ethanol swell index should be sufficient for the matrix material to be easily separated from the optical glass fibers by rubbing with an abrasive surface or peeling the swelled matrix material.

In one embodiment, the compositions of the present invention, when cured, possess an ethanol swell index of greater than about 9% by weight after immersion in ethanol/water for up to 20 minutes at room temperature. In another embodiment, the compositions of the present invention, when cured, possess an ethanol swell index of greater than about 17% by weight, preferably greater than about 20% by weight after immersion in ethanol/water for up to 40 minutes at room temperature.

At the same time, for end-access using the heat stripping method, the Tg of the cured matrix material should be high enough to maintain sufficient structural integrity of the matrix material as it is being separated from the optical glass fibers. If the Tg is not sufficiently high to retain the structural integrity of the matrix material, the matrix material will disadvantageously break apart when it is being separated from the optical glass fibers.

The Tg of the cured matrix material should also be high enough such that when force is applied to the matrix material to separate the heat-softened matrix material from the optical glass fibers sufficient force is transmitted through the matrix material, and any intervening coatings present on the optical glass fibers, to the primary coating on the optical glass fibers to thereby separate the heat-softened primary coating from the optical glass fibers. In this manner, when the cured matrix material according to the invention is separated from the glass optical fibers, the matrix material and primary coatings can be efficiently and rapidly separated from the optical glass fibers, so as to provide bare optical glass fibers to which connections can be made.

The Tg measurement (DMA test method) is described in greater detail below.

In one embodiment, the compositions of the present invention have a Tg of at least about 40° C. In another embodiment, the compositions of the present invention have a Tg of at least about 50° C. In another embodiment, the compositions of the present invention have a Tg from about 40° C. to about 120° C. In a further embodiment, the compositions of the present invention have Tg from about 50° C. to about 100° C.

The temperature of the heat stripping tool required will depend on the Tg of the matrix material. The higher the Tg of the matrix composition, the higher the temperature that can be applied to matrix material while retaining structural integrity of the matrix material. A typical temperature used to heat strip the matrix material is about 90° C.

The optical glass fiber ribbon assemblies made according to this invention can be used in telecommunication systems. Such telecommunication systems typically include optical glass fiber ribbon assemblies containing optical glass fibers, transmitters, receivers, and switches. The assemblies containing the optical glass fiber are the fundamental connecting units of telecommunication systems. The assemblies can be buried under ground or water for long distance connections, such as between cities.

### EXAMPLES

The invention will be further explained by the following non-limiting examples (Ex.1-Ex.5) within the scope of the present invention and comparative examples (C.1-C.2) outside the scope of the present invention.

Radiation curable matrix forming compositions were made by combining the ingredients shown in the following Table 1. These compositions were then coated onto 10-mil polyester films with a coating of reacting a polyol, a polyisocyanate, and a hydroxyl group-containing (meth)acrylate a thickness of 75 cm. The samples were then cured using UV light with a cure dose of 1J/cm² in a nitrogen atmosphere using fusion D-lamp. It is understood that the experimental results obtained from these coated films are compatible with the data obtained from the coatings generated on optical fiber made using an actual draw tower.

The properties of the coating compositions before and after cure were evaluated using test methods as described herein. The results are shown in Table 1.

TABLE 1

| Formula Ingredient: | Ex. 1 | Ex. 2 | Ex. 3 | Ex. 4 | Ex. 5 | C. 1 | C. 2 |
|---|---|---|---|---|---|---|---|
| Urethane Acrylate Oligomer A(Mw~1580) | 53.65 | 41.31 | 20.31 | 41.31 | 19.67 | | |
| Urethane Acrylate Oligomer B (Mw~4756) | 5.00 | 8.53 | 21.53 | 8.53 | 20.85 | | |
| Urethane Acrylate Oligomer C (Mw~1101) | | 10.13 | 15.05 | 10.13 | 14.56 | | |
| Urethane Acrylate Oligomer D (Mw~406) | | 8.40 | 12.48 | 8.40 | 12.08 | | |
| Urethane Acrylate Oligomer E (Mw~1230) | | | | | | 38.85 | |
| Urethane Acrylate Oligomer F (Mw~1230) | | | | | | | 62.16 |
| THEICTA | 18.60 | | | | | | |
| Vinyl Caprolactam | 11.20 | | | | | | 16.12 |
| Isobornyl acrylate | | 19.13 | 25.13 | 17.07 | 21.37 | 9.72 | |
| TPGDA | 7.00 | | | 2.06 | 2.96 | | |
| TMPTA | | 8.0 | 1.0 | 8.00 | 4.00 | | 4.00 |
| CN120Z | | | | | | 28.8 | |
| Ethoxylated bisphenol A diacrylate | | | | | | | 14.21 |
| Hexamethylene diacrylate | | | | | | 6.56 | |
| 2-Phenoxy Ethyl Acrylate | | | | | | 12.05 | |
| Irgacure 184 Photoinitiator | 3.00 | | | | 3.00 | | 1.00 |
| Darocure 1173 Photoinitiator | | 3.00 | 3.00 | 3.00 | | | |
| Chivacure TPO | | | | | | 2.00 | 2.00 |
| Irganox 1035 | 0.50 | 0.50 | 0.50 | 0.50 | 0.50 | | |
| Irganox 245 | | | | | | 0.50 | |
| Tinuvin 292 | | | | | | 0.50 | |
| DC 57 Additive | 0.35 | 0.35 | 0.35 | 0.35 | 0.35 | 0.36 | 0.18 |
| DC 190 Additive | 0.65 | 0.65 | 0.65 | 0.65 | 0.65 | 0.66 | 0.33 |
| Weight % Total: | 100.00 | 100.00 | 100.00 | 100.00 | 100.00 | 100.00 | 100.00 |
| Viscosity: mPas, 25° C. | 6013 | 6950 | 6200 | 6900 | 6550 | 5700 | 9300 |
| Cured Films 75 μm, 1 J/cm², N₂ | | | | | | | |
| Tensile strength: MPa | 19 | 16 | 15 | 16 | 17 | 30 | 30 |
| Elongation at break: % | 38 | 37 | 48 | 40 | 40 | 10 | 40 |
| Secant modulus: MPa, 2.5% | 285 | 235 | 240 | 228 | 315 | 309 | 730 |
| Tg: DMA max. Tan δ ° C. | 101 | 63 | 62 | 62 | 66 | 55 | 70 |
| Polydispersity index: (PDI) | 3.0:1 | 11.7:1 | 11.7:1 | 11.7:1 | 11.7:1 | 1:1 | 1:1 |
| E′₁₀₀–E′₁₀₀₀: ° C. | 99 | 53 | 49 | 53 | 52 | 29 | 40 |
| EtOH Swell Index @ 20 min: wt % | 23.0 | 18.2 | 22.8 | 19.2 | 19.6 | 3.5 | 8.8 |
| EtOH Swell Index @ 40 min: wt % | 23.4 | 21.1 | 25.2 | 20.4 | 22.2 | 5.2 | 15.6 |

### Reactants:

Urethane acrylate oligomer A: Polypropylene glycol-based, aromatic urethane acrylate oligomer represented by the structure H-T-PPG1000-T-H.
H represents 2-Hydroxy ethyl acrylate.
T represents toluene diisocyanate.
Urethane acrylate oligomer B: Polypropylene glycol-based, aromatic urethane acrylate oligomer represented by the structure H-T-PPG1000-T-PPG2000-T-H.
H and T are as previously described.
Urethane acrylate oligomer C: Polypropylene glycol-based, aliphatic urethane acrylate oligomer represented by the structure H-I-PPG425-I-H.
Urethane acrylate oligomer D: Oligomer represented by the structure H-T-H.
H and T are as previously described.
I represents isophorone diisocyanate.
Urethane acrylate oligomer E: Polytetramethylene ether glycol-based, aromatic urethane acrylate oligomer represented by the structure H-T-PTHF 650-T-H.
H and T are previously described.
Urethane acrylate oligomer F: Polytetramethylene ether glycol-based, aromatic urethane acrylate oligomer represented by the structure H-T-PTHF 650-T-H.
H and T are previously described.
PPG: Polypropylene glycol (BASF)
PTHF 650 (Polymeg 650): Polytetramethylene ether glycol (Lyondell)
THEICTA: Tris hydroxy ethyl isocyanurate triacrylate (Sartomer).
TPGDA: Tripropylene glycol diacrylate (Sartomer).
TMPTA: Trimethylolpropane triacrylate (Sartomer).
IBOA: Isobornyl acrylate (SR506: Sartomer).
DC-57: Di-methyl, methyl(polyethyleneoxide acetate-capped) siloxane, polyethylene glycol diacetate, polyethylene glycol allyletheracetate (TAB).
DC-190: Di-methyl, methyl(propylpolyethylene oxide polypropylene oxide, acetate) siloxane (TAB).
Irgacure 184: 1-hydroxycyclohexylphenyl ketone (Ciba Geigy).
Irganox 1035: Thioldiethylenebis(3,5-di-tertbutyl-4-hydroxy)hydrocinnamate (Ciba Geigy).
Irganox 245: Triethylene glycol-bis-3-(t-butyl-4-hydroxy-5-methyl-phenyl)-propionate (Ciba Geigy).
Darocure 1173:2-hydroxy-2-methyl-1-phenylpropan-1-one (Ciba Geigy).
CN120Z: epoxy acrylate (Sartomer).
Tinuvin 292: Bis(1,2,2,6,6-pentamethyl-4-piperidinyl)sebacate (Ciba Geigy).

The radiation curable composition in these examples, when coated and cured onto a plurality of coated optical fibers as a matrix material, provides mid-span access of the individual optical glass fiber using the heat stripping method and end-access of the individual optical glass fibers using the solvent stripping method. The radiation curable compositions which are represented by comparative examples C1-C2, when coated and cured onto a plurality of coated optical fibers as a matrix material, do not possess the combination of properties to allow both mid-span access of the optical glass fibers using the solvent stripping method and end-access of the optical glass fibers using the heat stripping method.

### Test Methods:

### Ethanol Swell Index:

The ethanol swell index of a cured matrix material is measured by immersing the cured matrix material in a mixture of ethanol and water. The ethanol concentration is 70% by volume of anhydrous denatured ethanol (containing less than 8% of denaturants) in de-ionized or distilled water. The times chosen for immersion of for the samples are 20 and 40 minutes.

A sample was prepared by casting a film of the material with a thickness of 150 microns (6 mils±1 mil) on polyester film with a thickness of 4 mils. The film was cured under nitrogen using a Fusion UV D-lamp. A dose of 1 J/cm² was used as measured by an International Light Bug Radiometer Model IL390B. Three approximately 2.5 cm×2.5 cm (1″×1″) sample specimens were cut from the cured film using a cutting device.

The three film samples were first dried at 60° C.±3° C. in an oven for 1 hour and were immediately placed in a dessicator with less 20% Relative Humidity for at least 15 minutes. The samples were then weighed and immersed in the ethanol-water solution at room temperature (23° C.±3° C.) for 20 minutes. After the allotted time, the samples were removed, blotted dry to remove any excess liquid by Kimwipe and quickly reweighed. Subsequently, the samples were immediately reimmersed in the ethanol-water solution for an additional 20 minutes, removed, blotted dry to remove any excess liquid by Kimwipe and quickly reweighed.

The swell index (%) of each sample is calculated from the below formula:

$$Swell index = \frac{Net weight of sample - Original weight of sample}{Original weight of sample} \times 100$$

The swell indices of three samples are averaged to provide the swell index of the matrix material.

### DMA (Dynamic Mechanical Analysis) Test Method:

DMA was carried out on the test samples, using a Rheometrics Solids Analyzer (RSA-11) to measure the elastic modulus (E′), the viscous modulus (E″), and the tan delta (E″/E′) of the samples. The maximum value of the tan delta measured is the Tg.

The test samples were prepared by casting a film of the material, having a thickness in the range of 1.0 mm to 10.0 mm, on a polyester film with a thickness of 4 mils. The sample film was cured using a UV processor with a cure dose of 1J/cm² under nitrogen atmosphere. A specimen approximately 35 mm (1.4 inches) long and approximately 12 mm wide was cut from a defect-free region of the cured film.

The film thickness of the specimen was measured at five or more locations along the length. The average film thickness was calculated to ±0.001 mm. The thickness cannot vary by more than 0.01 mm over this length. Another specimen was taken if this condition was not met. The width of the specimen was measured at two or more locations and the average value calculated to ±0.1 mm.

The geometry of the sample was entered into the instrument. The length field was set at a value of 23.2 mm and the measured values of width and thickness of the sample specimen were entered into the appropriate fields.

Before conducting the temperature sweep, moisture was removed from the test samples by subjecting the test samples to a temperature of 80° C. in a nitrogen atmosphere for 5 minutes. The temperature sweep used included cooling the test samples to about −60° C. or about −80° C. and increasing the temperature at about 1° C./minute until the temperature reached a point at which the equilibrium modulus has been reached. The test frequency used was 1.0 radian/second.

For the matrix compositions of the present invention, the difference between the temperature at the DMA-derived elastic modulus E′₁₀₀ and the temperature at the DMA-derived elastic modulus E′₁₀₀₀ is at least about 35° C. In another embodiment, the difference between the temperature at the DMA-derived elastic modulus E′₁₀₀ and the temperature at the DMA-derived elastic modulus E′₁₀₀₀ is at least about 45° C.

While the invention has been described in detail and with reference to specific embodiments thereof, it will be apparent to one of ordinary skill in the art that various changes and modifications can be made therein without departing from the spirit and scope of the claimed invention.

1) A radiation curable composition comprising:
a) At least two urethane(meth)acrylate oligomers;
b) One or more multifunctional diluents;
c) One or more photoinitiators;
wherein:
i) the urethane(meth)acrylate oligomers are non-silicone oligomers;
ii) each of the urethane(meth)acrylate oligomers has a number average molecular weight of about 200 or more, but less than about 6000; and
iii) the polydispersity index of the urethane(meth)acrylate oligomers is from about 2:1 to about 30:1.

2) The composition according to claim 1, wherein said composition, when cured, has an ethanol swell index greater than about 9% by weight after immersion of up to about 20 minutes at room temperature.

3) The composition according to claim 1, wherein said composition, when cured, has an ethanol swell index of greater than about 20% by weight after immersion for up to about 40 minutes at room temperature.

4) The composition according to claim 1, wherein said composition, when cured, has a glass transition temperature (Tg) of at least about 40° C.

5) The composition according to claim 1, wherein the difference between the temperature at the DMA-derived elastic modulus E′₁₀₀ and the temperature at the DMA-derived elastic modulus E′₁₀₀₀ is at least 35° C.

6) The composition according to claim 1, wherein the difference between the temperature at the DMA-derived elastic modulus E′₁₀₀ and the temperature at the DMA-derived elastic modulus E′₁₀₀₀ is at least 45° C.

7) The composition according to claim 1, wherein said non-silicone urethane(meth)acrylate oligomers have a polyol backbone based on polyether polyol, polyester polyol, polycarbonate polyol, polycaprolactone polyol or copolymers thereof.

8) The composition according to claim 7, wherein said backbone comprises one or more oligomeric blocks.

9) The composition according to claim 1, wherein said non-silicone urethane(meth)acrylate oligomers comprise polyether polyol backbone.

10) The composition according to claim 9, wherein said polyether polyol backbone comprises more than one oligomeric polyether block.

11) The composition according to claim 1, wherein said composition further comprises:
d) a monofunctional diluent.

12) The composition according to claim 11, wherein said monofunctional diluent is an acrylate diluent.

13) The composition according to claim 1, wherein said composition further comprises:
d′) an antioxidant.

14) The composition according to claim 11, wherein said composition further comprises:
e) an antioxidant.

15) The composition according to claim 1, wherein said composition further comprises:
d″) a silicone additive.

16) The composition according to claim 1, wherein said composition, when cured, has a secant modulus of about 100 MPa to about 600 MPa.

17) The composition according to claim 1, wherein said composition, when coated and cured onto a plurality of coated optical fibers, provides:
(i) an ethanol swell index greater than about 9% by weight after immersion for up to about 20 minutes at room temperature; and
(ii) a glass transition temperature (Tg) of at least about 40° C.

18) The composition according to claim 1, wherein said composition, when coated and cured onto a plurality of coated optical fibers, provides:
(ii) an ethanol swell index greater than about 20% by weight after immersion of up to about 40 minutes at room temperature;
(ii) a glass transition temperature (Tg) of at least about 50° C.

19) A radiation curable composition comprising:
a) about 40 wt % to about 90 wt %, relative to the total weight of the composition, of at least two urethane(meth)acrylate oligomers;
b) about 1 wt % to about 30 wt %, relative to the total weight of the composition, of one or more multifunctional diluents;
c) about 10 wt % to about 35 wt %, relative to the total weight of the composition, of one or more monofunctional diluents;
d) about 0.5 wt % to about 8 wt %, relative to the total weight of the composition, of one or more photoinitiators;
e) about 0.1 wt % to about 3 wt %, relative to the total weight of the composition, of one or more antioxidants;
f) about 0.1 wt % to about 3 wt %, relative to the total weight of the composition, of one or more silicone additives, wherein
i) the urethane(meth)acrylate oligomers are non-silicone oligomers;
ii) each of the urethane(meth)acrylate oligomers has a number average molecular weight of about 200 or more, but less than about 6000; and
iii) the polydispersity index of the urethane(meth)acrylate oligomers is from about 2:1 to about 30:1.

20) An optical fiber ribbon assembly comprising:
(a) a plurality of coated optical glass fibers; and
(b) a matrix material binding the plurality of coated optical glass fibers together, wherein the matrix material is a cured radiation-initiated polymerization reaction product of a radiation curable composition comprising:
1) At least two urethane(meth)acrylate oligomers;
2) One or more multifunctional diluents;
3) One or more photoinitiators;
wherein:
i) the urethane(meth)acrylate oligomers are non-silicone oligomers;
ii) each of the urethane(meth)acrylate oligomers has a number average molecular weight of about 200 or more, but less than about 6000; and
iii) the polydispersity index of the urethane(meth)acrylate oligomers is from about 2:1 to about 30:1.

21) A method of making an optical fiber assembly ribbon comprising:
(A) applying on a plurality of coated optical glass fibers a matrix coating of a radiation-curable matrix material having a composition comprising:
1) At least two urethane(meth)acrylate oligomers;
2) One or more multifunctional diluents;
3) One or more photoinitiators;
wherein:
i) the urethane(meth)acrylate oligomers are non-silicone oligomers;
ii) each of the urethane(meth)acrylate oligomers has a number average molecular weight of about 200 or more, but less than about 6000; and
iii) the polydispersity index of the urethane(meth)acrylate oligomers is from about 2:1 to about 30:1, and thereafter
(B) exposing the matrix coating applied according to step (A) to radiation sufficient to cure the matrix material and bind the plurality of optical fibers together.

22) A cured material which is the radiation-initiated reaction product of a curable resin composition according to claim 1.
